(19) United States
(12) Patent Application Publication
(10) Pub. No.: US 2010/0245608 A1
(43) Pub. Date: Sep. 30, 2010

(54) ADAPTIVE METHOD AND SYSTEM FOR EXTRACTING A BRIGHT IMAGE FROM A THERMAL IMAGE

(75) Inventors: Tim K. Trudeau, Roanoke, VA (US); Tibor Kozek, Berkeley, CA (US)

Correspondence Address: RATNERPRESTIA, P.O. BOX 980, VALLEY FORGE, PA, 19482, US

(73) Assignee: ITT MANUFACTURING ENTERPRISES, INC., Wilmington, DE (US)

(21) Appl. No.: 12/410,714

(22) Filed: Mar. 25, 2009

(51) Int. Cl. H04N 5/225; G06K 9/00

(52) U.S. Cl. 348/222.1; 382/172; 348/E05.024

(57) ABSTRACT

An image processor computes a raw histogram for an unprocessed raw digital image. The image processor positions a clip point at an intensity level within the raw image histogram. The pixels having an intensity level less than the intensity level of the clip point are blacked-out (reduced in intensity). The remaining illuminated pixels are displayed.

### FIELD OF INVENTION

This invention relates, generally, to extracting information from digital video in real time. More specifically, this invention relates to adaptively selecting an intensity threshold (clip point) based on a pixel histogram from an unprocessed (raw) camera input, below which image content is then suppressed.

### BACKGROUND OF THE INVENTION

In some imaging systems such as night vision, it is desirable to extract specific information from a scene. One type of information to be extracted may be temperature information. In order to accentuate high intensity thermal objects such as humans from low intensity thermal objects found in background scenes, background information may be suppressed using thresholding. Thresholding suppresses image content below a set intensity threshold, also referred to as a clip point. Thus, the post processed (clipped) image contains pixel information with intensity values greater than the threshold. This operation is generally known as intensity thresholding.

In intensity thresholding, a pixel histogram may be computed from an image. The pixel histogram is the distribution of pixel intensity values taken from the image. Specifically, the pixel histogram shows the number of pixels that fall within each intensity value across a range of intensity values. The range of intensity values within a digital image is a function of the bit depth (or word size) supported by the camera. Digital cameras may have word sizes of 8 bits, 10 bits, 16 bits or higher. A camera with a 16 bit word size generally may not detect 65536 intensity values in a video frame. Therefore the minimum and maximum pixel intensity values contained in a video frame define a narrow range within the larger range of 0 to 65536. The range between the minimum and maximum intensity values is known as the histogram support. Intensity thresholding may be performed by setting a clip point at an intensity value within the histogram support.

One problem that may occur in intensity thresholding, is deciding where the threshold should be positioned during changing scene conditions. Due to changing operating environments, fixed thresholds are ineffective. For example, changes in ambient temperature may result in an overall shift in a pixel histogram support within the overall intensity range. As the overall intensity levels of the histogram shift, a fixed threshold may not be effective in extracting the desired thermal information from the image.

The present invention provides an adaptive system for setting the intensity threshold. Specifically, the intensity threshold automatically adjusts according to varying scene conditions and operating environments, to provide a desirable output image.

### SUMMARY OF THE INVENTION

To meet this and other needs, and in view of its purposes, the present invention provides an image processor for setting a clip point at an intensity value below which pixel values from an image are suppressed. The image processor includes a raw histogram module for computing a raw histogram of pixels in the image; a clip point positioning module for positioning a clip point at a pixel intensity level within the raw histogram; and a suppression module for reducing the intensity levels of the pixel values in the image that are lower than the intensity level of the clip point. The clip point positioning module positions the clip point at a low intensity level within the raw histogram. The clip point positioning module positions the clip point at an intensity level within the raw histogram corresponding to a bin having the greatest number of pixels per bin.

Also included are a contrast stretch module which stretches the raw histogram of the image; and a display space mapping module which maps the stretched histogram and the clip point to a reduced bit level display histogram. A positional relationship between the raw histogram and clip point is similarly maintained between the display histogram and mapped clip point. The suppression module produces a clipped image by reducing the intensity level of the pixels in the display histogram that have an intensity level lower than the intensity level of the clip point.

Also included are a display for displaying the illuminated pixels remaining in the clipped image; and a micro-bolometer sensor for generating the image being processed by the image processor. The raw histogram is computed from the image produced by the micro-bolometer sensor.

Another embodiment of the present invention includes a thermal video camera system. The thermal video camera system includes: a micro-bolometer sensor for producing a raw thermal image; an image processor for processing the raw thermal image; and a display device for displaying the processed thermal image. The image processor includes: a raw histogram module for computing a raw histogram of the raw thermal image pixel values, a clip point positioning module for positioning a clip point at a pixel intensity level within the raw histogram, and a suppression module for reducing the intensity levels of the pixel values in the thermal image that are lower than the intensity level of the clip point. The clip point positioning module positions the clip point at a high intensity level within the raw histogram.

Also included is a manual control module allowing a viewer to manually adjust the clip point position set by the clip point positioning module for changing the number of illuminated pixels being displayed. The clip point is manually adjusted by the viewer after the clip point positioning module initially positions the clip point in the raw histogram.

Also included is an automatic temperature compensation module which controls the clip point positioning module to adjust the clip point based on a focal plane temperature or an enclosure temperature.

Another embodiment of the present invention includes a method for setting a clip point below which low intensity pixel values from an image are suppressed. The method comprises computing the raw histogram of the image; positioning a clip point at an intensity level within the raw histogram; contrast stretching and mapping the raw histogram to a reduced bit level display histogram; and blacking-out the pixels having intensity lower than the intensity level of the clip point. Furthermore, the clip point is positioned at a low intensity level within the raw histogram. The clip point is positioned at an intensity level within the raw histogram corresponding to a bin having the greatest number of pixels per bin. The illuminated pixels remaining in the clipped image are displayed. The number of illuminated pixels in the displayed image are changed by manually adjusting the position of the clip point. The clip point is repositioned as the raw histogram changes with changes in scene conditions and operating environments, to continuously maintain a position within the he raw histogram.

It is understood that the foregoing general description and the following detailed description are exemplary, but are not restrictive, of the invention.

### BRIEF DESCRIPTION OF THE DRAWINGS

FIG. 1 is a schematic diagram of a thermal video camera system, in accordance with an embodiment of the present invention;

FIG. 2 is a representative raw pixel histogram of an image as shown in FIG. 20;

FIG. 3 is a quantized and contrast stretched display space histogram of the raw data histogram in FIG. 2;

FIG. 4 is a clipped histogram of the display space histogram in FIG. 3;

FIG. 5 is a representative raw pixel histogram of an image as shown in FIG. 22;

FIG. 6 is a quantized and contrast stretched display space histogram of the raw data histogram in FIG. 5;

FIG. 7 is a clipped histogram of the display space histogram in FIG. 6;

FIG. 8 is a representative raw pixel histogram of an image as shown in FIG. 20 including a clip point positioned within the data support;

FIG. 9 is a quantized and contrast stretched display space histogram of the raw data histogram in FIG. 8 including a clip point or threshold mapped from the raw data histogram to the display space histogram;

FIG. 10 is a clipped histogram of the display space histogram in FIG. 9;

FIG. 11 is a representative raw pixel histogram of an image as shown in FIG. 22 including a clip point positioned within the data support;

FIG. 12 is a quantized and contrast stretched display space histogram of the raw data histogram in FIG. 11 including a clip point or threshold mapped from the raw data histogram to the display space histogram;

FIG. 13 is a clipped histogram of the display space histogram in FIG. 12;

FIG. 14 is a representative raw pixel histogram of an image as shown in FIG. 20 at a temperature of T1, including a clip point positioned within the data support;

FIG. 15 is a quantized and contrast stretched display space histogram of the raw data histogram in FIG. 14 including a clip point or threshold mapped from the raw data histogram at temperature T1 to the display space histogram;

FIG. 16 is a clipped histogram of the display space histogram in FIG. 15, at temperature T1;

FIG. 17 is a representative raw pixel histogram of an image as shown in FIG. 20 at a temperature of T2, including a clip point not positioned within the data support;

FIG. 18 is a quantized and contrast stretched display space histogram of the raw data histogram in FIG. 17 including a clip point or threshold mapped from the raw data histogram at temperature T2 to the display space histogram;

FIG. 19 is a clipped histogram of the display space histogram in FIG. 18, at temperature T2;

FIG. 20 is a thermal image of a person standing in a wooded background scene;

FIG. 21 is a processed image where the wooded background scene in FIG. 20 has been clipped from the thermal image;

FIG. 22 is a thermal image of a person and a bright spot in a wooded background scene;

FIG. 23 is a processed image where most of the person as well as the wooded background scene in FIG. 22 have been clipped from the thermal image;

FIG. 24 is a processed image where the wooded background scene in FIG. 22 has been clipped from the thermal image; and

FIG. 25 is a detailed view of the image processor in FIG.1, including an external manual control module for adjusting the clip point position, in accordance with an embodiment of the present invention.

FIG. 26 is a detailed view of the image processor in FIG.1, including an automatic temperature compensation module for adjusting the clip point position according to the measured temperature, in accordance with an embodiment of the present invention.

### DETAILED DESCRIPTION OF THE INVENTION

As will be described, the present invention provides an adaptive thresholding technique for accentuating higher intensity pixels in an image by suppressing (clipping) lower intensity pixels. The present invention includes a micro-bolometer sensor for capturing a raw thermal image, an image processor for processing the raw thermal image and a display device for displaying the thermal image. In general, a raw image histogram is computed from the raw un-processed micro-bolometer image. A clip point is then positioned at an intensity level within the raw image histogram support. The clip point and raw image histogram are mapped to a reduced bit level display space histogram. Pixels with intensity levels lower than the clip point are reduced in intensity (clipped) from the image.

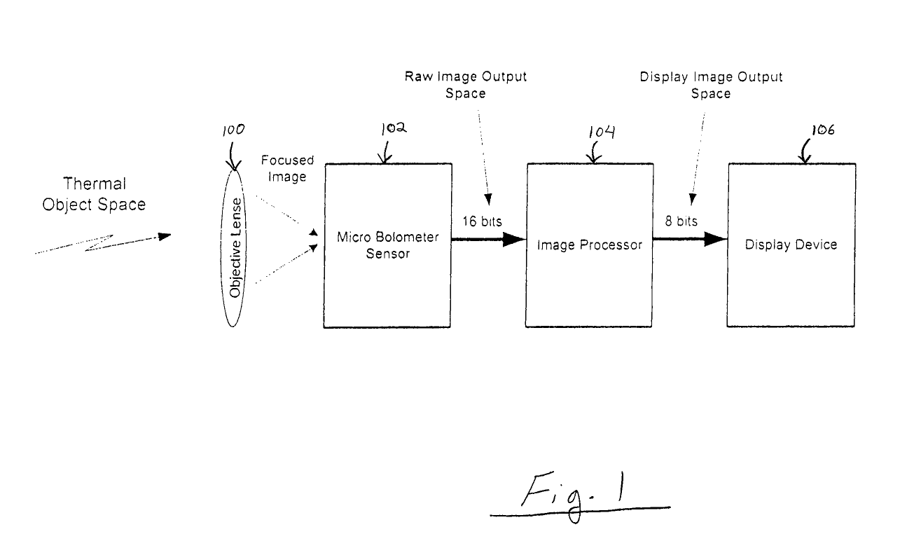

FIG. 1 shows a thermal video camera system. The thermal video camera system comprises objective lens 100 which focuses the thermal image to the input of micro-bolometer sensor 102, image processor 104 which operates on the 16-bit raw image output of micro-bolometer sensor 102 and converts it to an 8-bit display signal, and display device 106 that displays the processed 8-bit image.

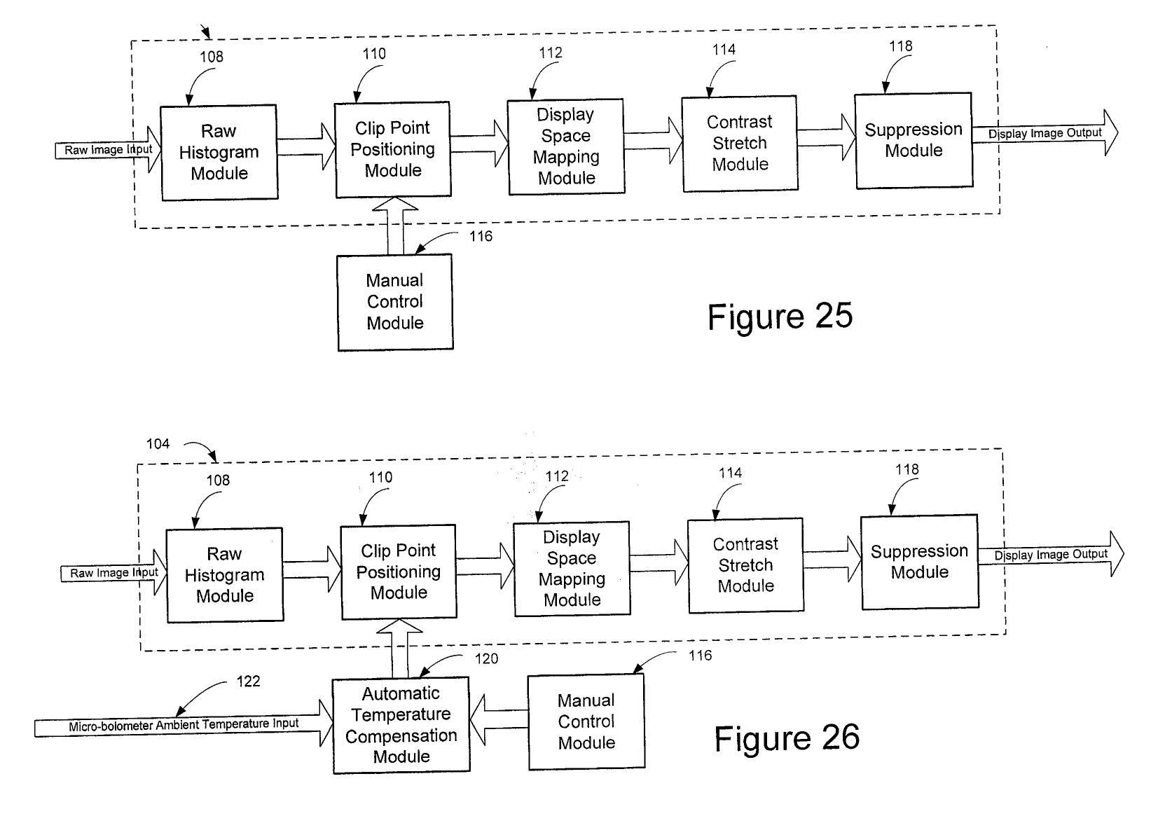

The general description of the operation of the thermal video camera system in FIG. 1 is now described with reference to FIG. 25. Micro-bolometer sensor 102 first detects a thermal image and quantizes the thermal image data into a 16-bit raw image space. Raw image histogram module 108 then computes a raw histogram of the 16-bit micro-bolometer image. Clip point positioning module 110 then positions a threshold clip point at an intensity level within the raw histogram support. Display space mapping module 112 and contrast stretch module 114 then map and stretch the raw histogram to an 8-bit image in the display space. The position of the clip point within the raw histogram is not changed when mapped to the display space. Contrast stretching may be performed by standard stretching algorithms known to those skilled in the art. After mapping to the display space, the pixels in the image that are lower in intensity than the set clip point intensity are “blacked-out” from the image by suppression module 118, whereas the pixels having higher intensity values than the clip point intensity are displayed by display device 106. Blacking-out pixels may be accomplished by reducing the pixel intensity to an intensity level of zero or some other predetermined intensity level. In general Blacking-out is an operation where the clipped pixels are visually suppressed in the output image.

In the present invention, image processor 104 automatically positions the clip point within the raw histogram support. The viewer that is viewing the display device 106, has the ability to perform manual adjustments on the clip point position via manual control module 116. For example, the viewer may adjust the clip point position to alter the display to his visual preference. If the viewer perceives the system as blacking-out too much pixel information such as lower intensity pixels of interest, the viewer may manually move the clip point to a lower intensity level position. If the viewer perceives the system as not blacking-out enough pixel information such as low intensity unwanted pixels, the viewer can manually move the clip point to a higher intensity level position.

In another embodiment of the present invention, an automatic temperature compensation module 120 is added as shown in FIG. 26. Changes in ambient temperature experienced by micro-bolometer 102 cause the support of the raw image histogram to shift within the total micro-bolometer intensity range. By supplying ambient temperature information 122 to automatic temperature compensation module 120, the position of the clip point may be automatically adjusted to maintain a position in the support of the shifted histogram. This adjustment mitigates the affect of the histogram shift due to changes in ambient temperature.

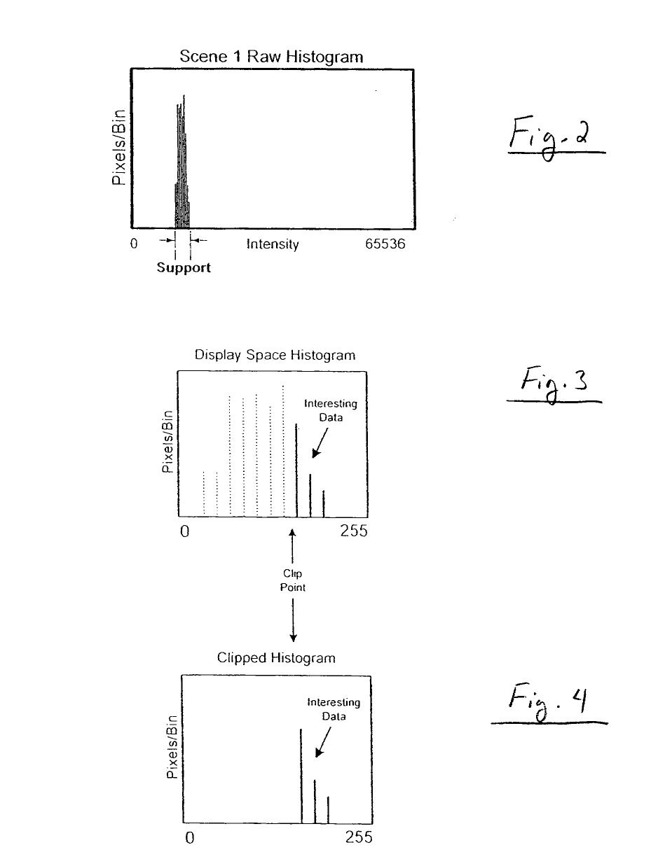

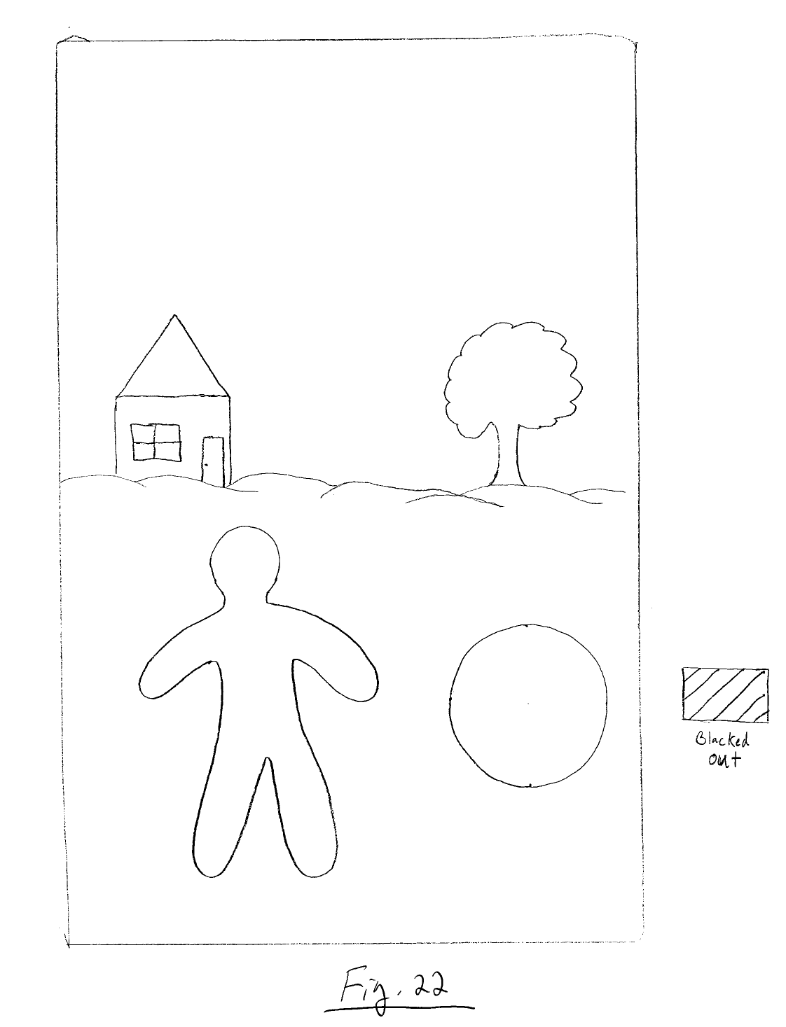

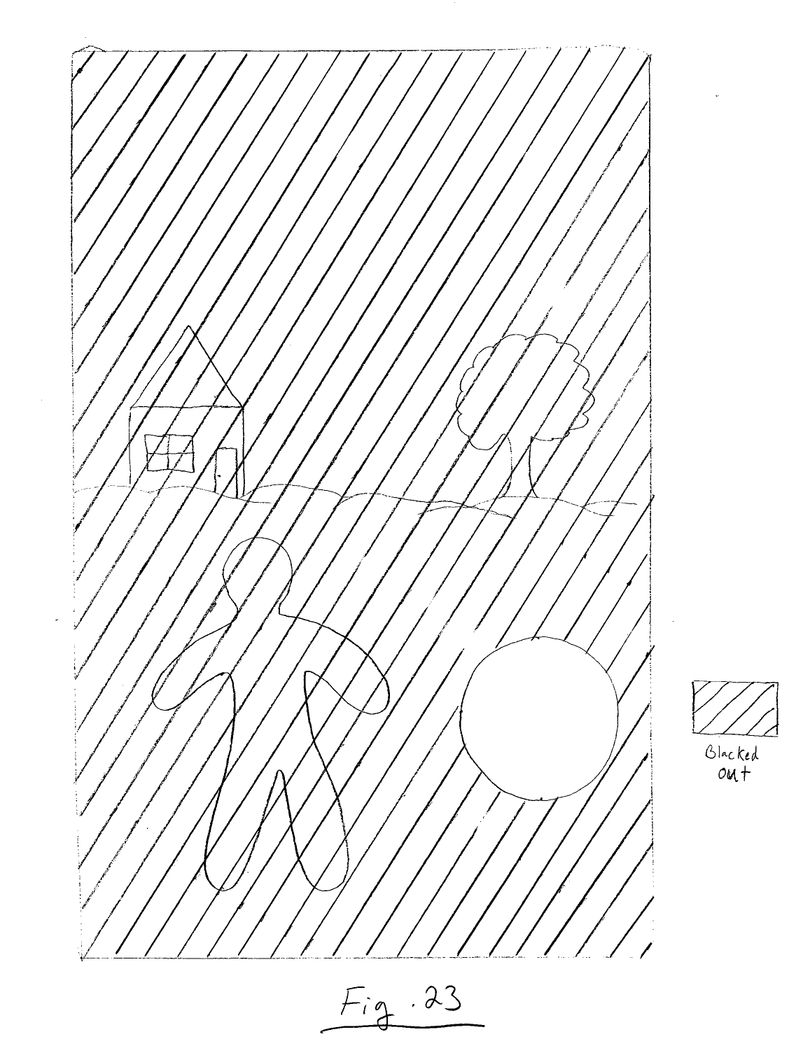

A key consideration of this invention is how the value of the clip point is set. The following two examples demonstrate the limitations of setting the value of the clip point within the display space. In FIG. 2, a raw histogram is computed from the un-processed raw image output of micro-bolometer 102. The support is defined as the region within the intensity range bounded by the minimum and maximum value of the raw image histogram. FIG. 3 shows the raw histogram mapped and stretched into an 8-bit display space histogram. In this particular example, the clip point is fixed at an intensity level in the display space. Pixels having intensity levels lower than the intensity level of the clip point are blacked-out. The resulting display space clipped histogram, shown in FIG. 4, results in FIG. 21 where the wooded background scene of FIG. 20 has been clipped from the image, and the high intensity thermal data (human) is retained.

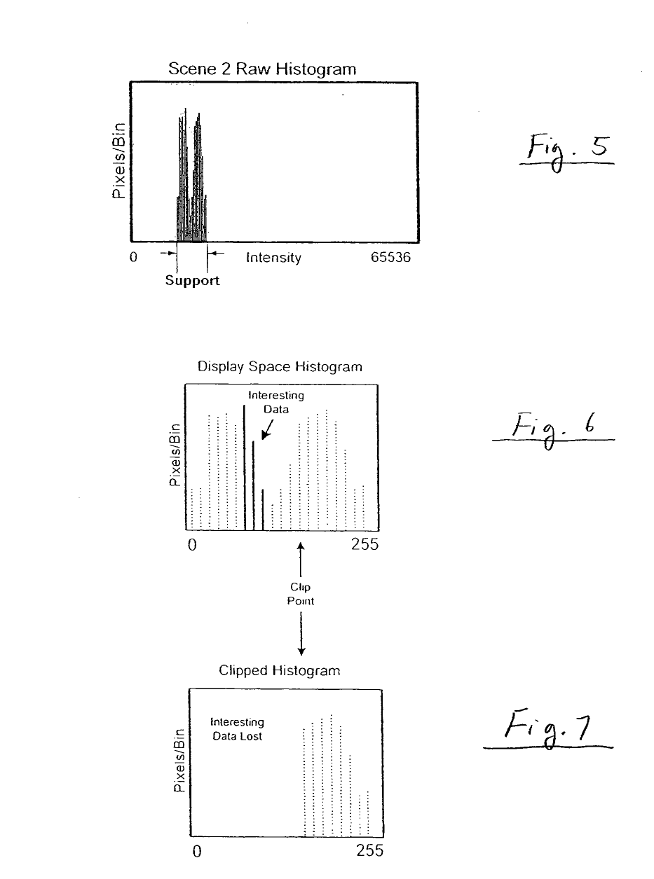

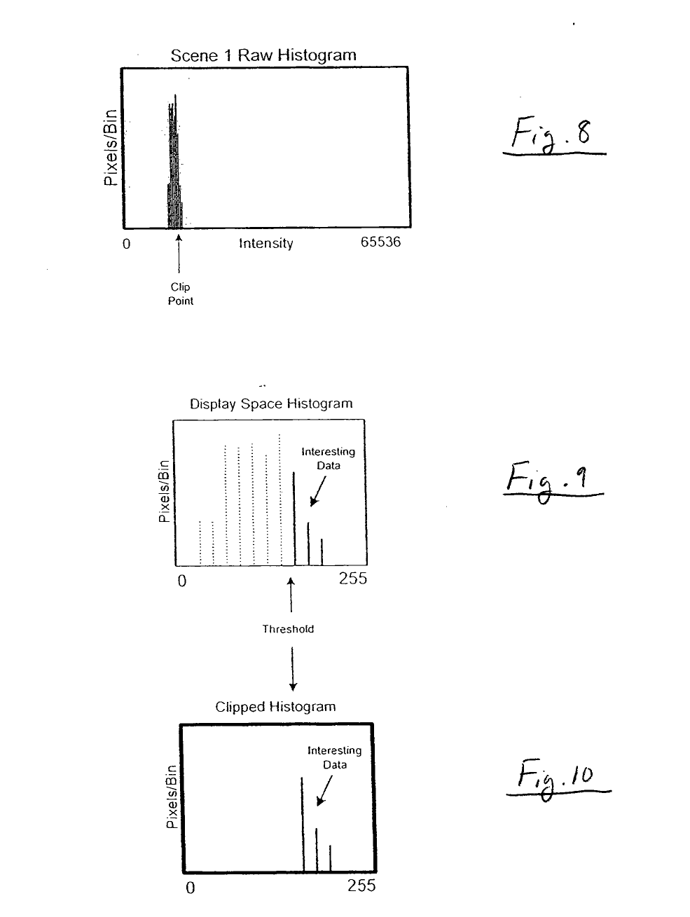

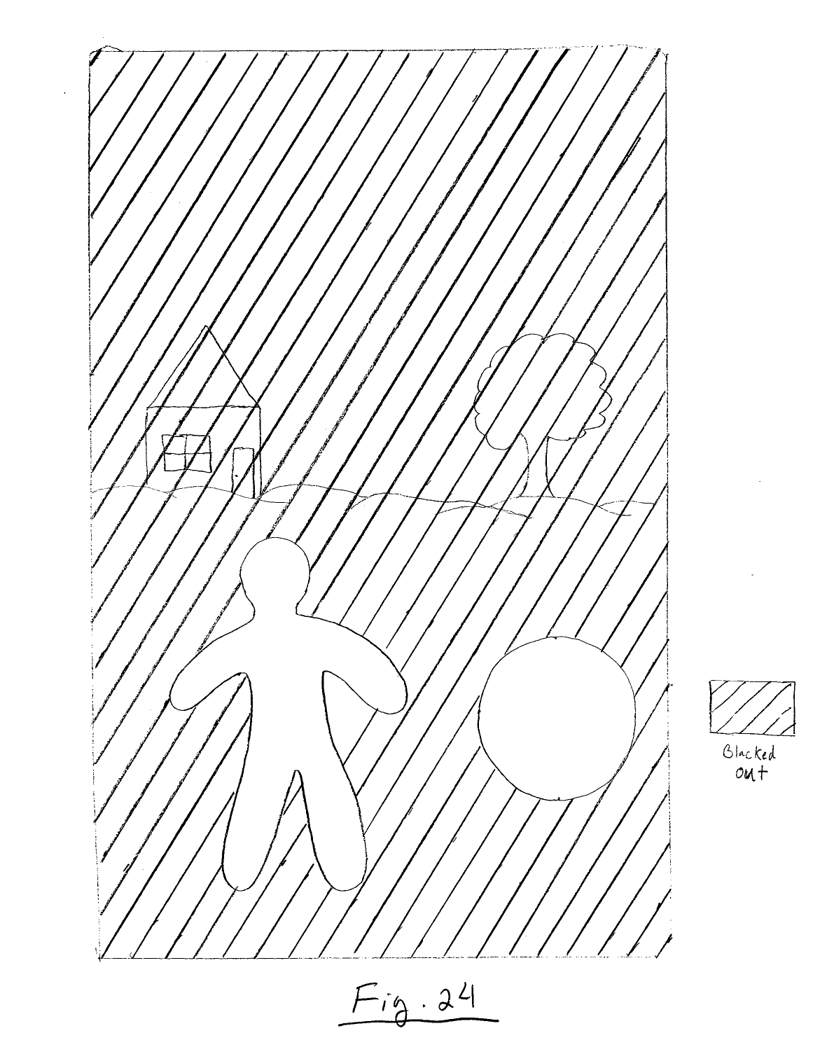

In another example shown in FIG. 5, is a raw histogram representative of FIG. 22. In FIG. 5, there are now two intensity peaks in the histogram, one representative of the person in FIG. 22 and the other representative of the bright spot in FIG. 22. The two peaks representative of the human and the bright spot result in a wider histogram support than shown in FIG. 2. If the value of the clip point is maintained in the display space as shown in FIG. 3 and FIG. 6, after the image processor 104 maps the raw histogram to the 8-bit display, the display space histogram of FIG. 6 results. Due to the wider support, the image data representative of the person in the image becomes shifted to the left of the clip point and suppressed as shown in FIG. 7. The pixels representative of the wooded background information as well as most of the pixels representative of the person then become blacked-out in FIG. 23, resulting in interesting information about the person being mistakenly removed.

In accordance with the present invention, and demonstrated by the following examples, image processor 104 positions the clip point within the support of the raw histogram as shown in FIG. 8. The display space mapping module maps not only the raw histogram to the display space, but also maps the clip point such that the relative position is maintained within the support of the display histogram as shown in FIG. 9. As in FIG. 4, interesting data representative of the person is maintained in FIG. 21 while the low intensity pixels representative of the unwanted background information are blacked-out.

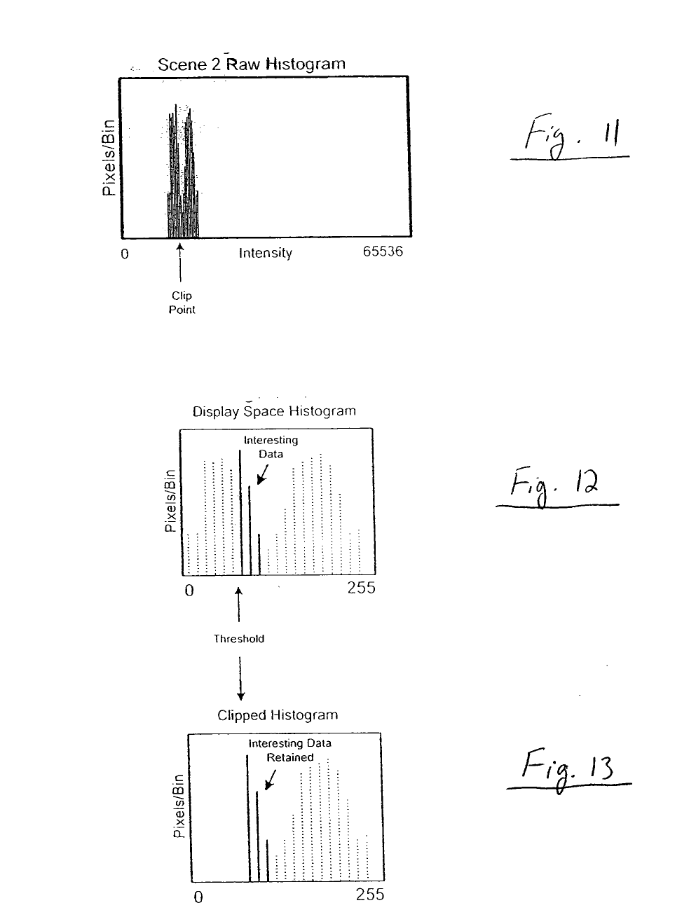

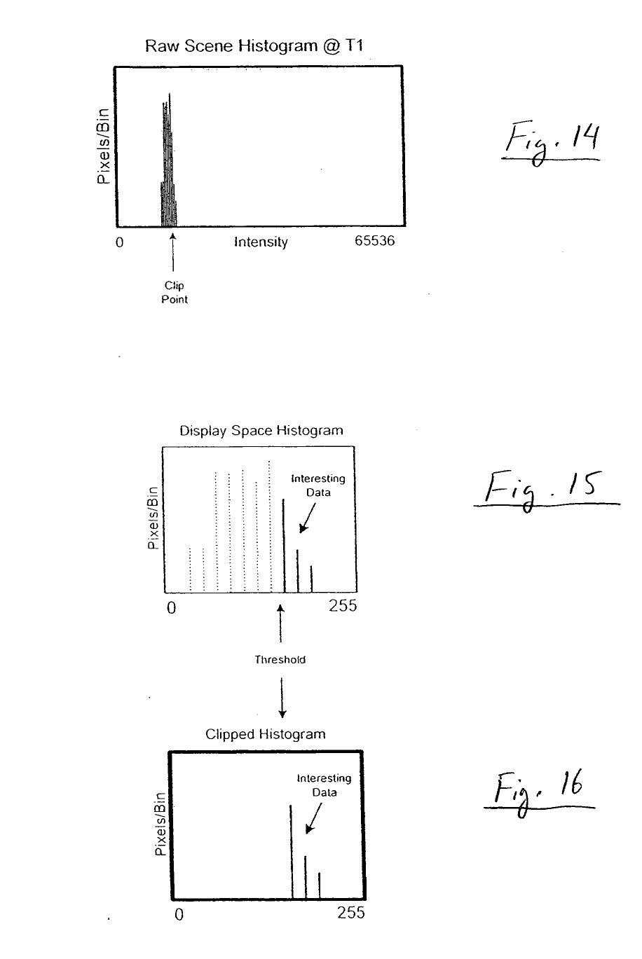

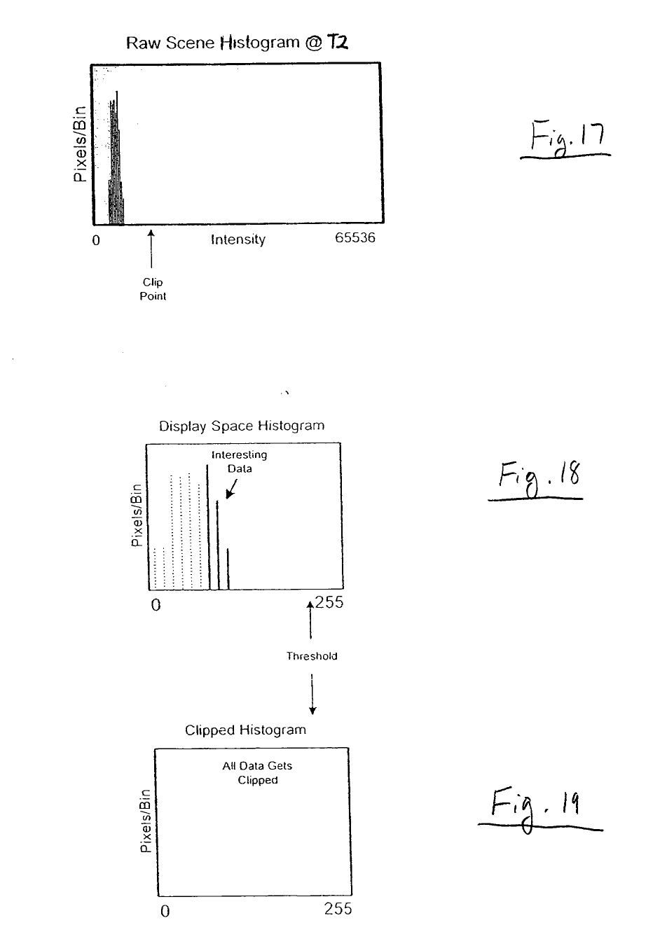

In the case where high intensity objects are added to the scene as shown in FIG. 22, the clip point remains positioned within the support of the raw image histogram. The display space mapping module maps the clip point such that the relative position of the resulting threshold is maintained within the support as shown in FIG. 12. The interesting data representative of the human as well as the second bright object in the image are retained as shown in FIG. 13.

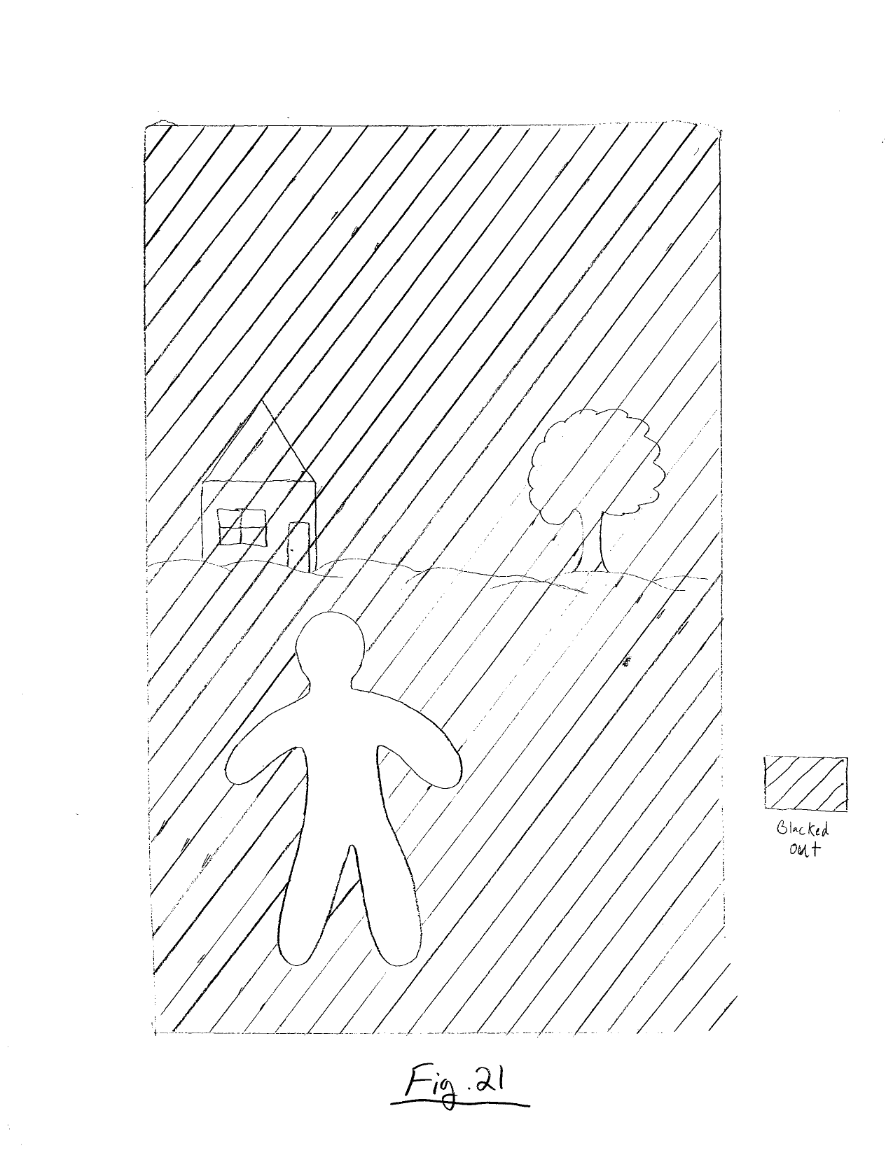

As previously described, thermal images may undergo changing scene conditions and operating environments. These changing conditions may be due to changes in temperature in the environment. As ambient temperature changes, the raw histogram may become shifted to either lower or higher intensity levels. An example of ambient temperature shift is shown in FIGS. 14 and 17.

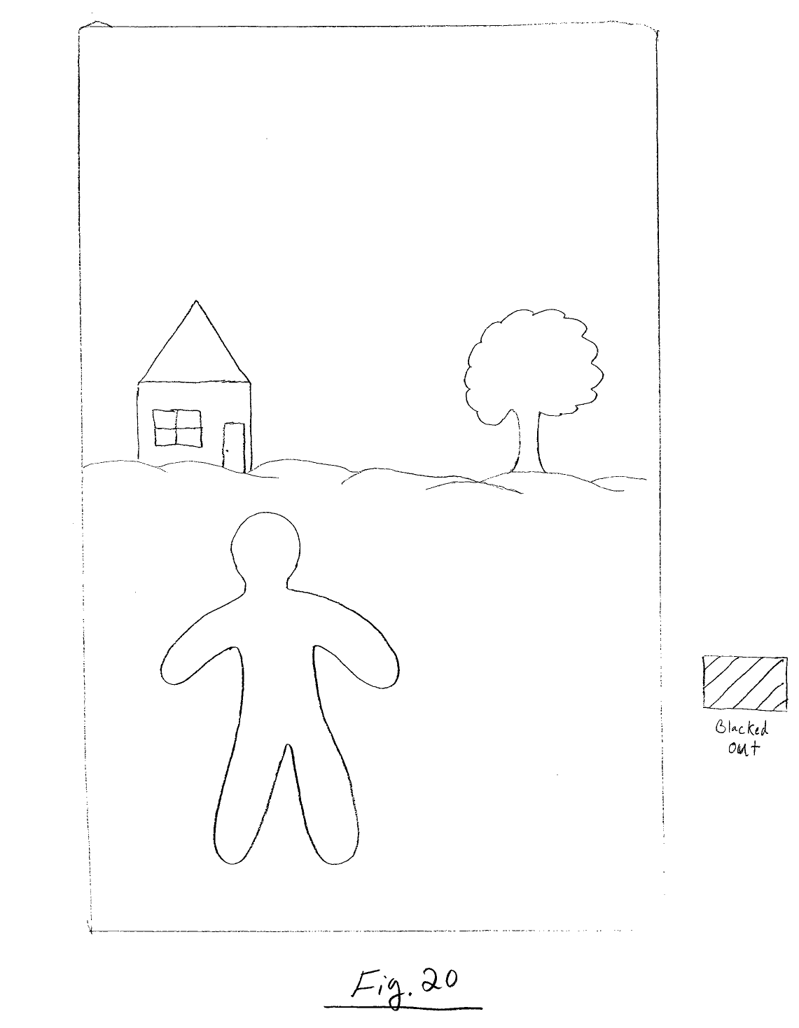

In FIG. 14, a raw histogram is computed in an environment having an ambient temperature of T1. As shown in FIG. 14, the clip point is positioned within the raw histogram support and is then correctly mapped and clipped in the display histograms shown in FIGS. 15 and 16. This allows the interesting data to be displayed and the unwanted background data to be clipped from the image.

In FIG. 17, however, a raw histogram is computed in an environment having a different ambient temperature of T2 (temperature shift). Since the ambient temperature of the environment shifted from temperature T1 to T2, the raw histogram has shifted to occupy overall lower intensity levels. If the clip point is not automatically adjusted as shown in FIG. 17, the system will effectively black-out all of the interesting data. This is because all of the data has shifted below the set clip point.

Thus, an advantage of the present invention is that the clip point as shown in FIG. 17 is automatically positioned by image processor 104 to be within the support of the raw histogram. This ensures that temperature shifts do not adversely affect the clipping of the image.

As previously described, image processor 104 automatically positions the clip point within the raw histogram support. The position in the raw histogram support where the clip point is positioned, may be computed in various ways. One example is for image processor 104 to position the clip point on the lower intensity side of the raw histogram. For example, the clip point may be positioned at a low intensity wherein a certain percentage of the lower intensity pixels are clipped from the image. This may provide a low intensity starting point where a small portion of the lower intensity pixels are clipped from the image and the majority of higher intensity pixels are displayed. In another example, the clip point may be positioned at an intensity level of the raw histogram corresponding to a bin having the greatest number of pixels per bin. In this example, approximately half of the image content is clipped from the image. In general, the clip point may be positioned anywhere within the support of the raw histogram.

In the previously described examples, the clip point is initially positioned by image processor 104 and then further adjusted by the viewer who is viewing display device 106. The viewer may manually reduce or increase the intensity level of the clip point to finely adjust the visual quality of the displayed image. Manual control module 116 provides a digital input to image processor 104. In general, the raw histogram support resides in a narrow range of the large 16-bit raw space. Therefore, it may be beneficial to map the raw histogram support from the 16-bit space to a lower bit space (for example 8-bits). The lower bit space, allows the viewer to finely adjust the clip point within the raw histogram support.

Since the clip point is automatically adjusted by clip point positioning module 110 and also may be manually adjusted by manual control module 116, it is beneficial to ensure that they do not conflict with each other. In one example, when the viewer manual adjusts the clip point, the automatic adjustment feature of clip point positioning module 110 is disabled. This ensures that the manual adjustments made by the viewer are not compromised by the automatic adjustments of 110. In another example, if the raw histogram support shifts away from the clip point during manual adjustment, the automatic adjustment of the clip point positioning module 110 overrides the manual adjustment. This ensures that the clip point maintains a position within the raw histogram support.

Another technique for positioning the clip point may be based on various measurements. Some of the possible clip point positioning techniques may include but are not limited to the following measurements: focal plane temperature and enclosure internal temperature.

A micro-bolometer camera measures temperature differences between a focal plan array (FPA) and heat sources within a scene. Changes in the ambient temperature in proximity to the FPA cause corresponding shifts in the position of the raw image histogram within the full intensity range of the camera. This shift is not due to thermal changes in the image, but rather due to the temperature changes of the FPA or enclosure. By adding an automatic temperature compensation module 120 shown in FIG. 26, changes in the temperature of the FPA or enclosure may be offset. The temperature information 122 is provided to the automatic temperature compensation module 120. This ensures that the manually selected clip point remains located in the same relative location within the raw image histogram support regardless of the any temperature changes in the proximity of the micro-bolometer camera.

Although the invention is illustrated and described here with reference to these specific embodiments, the invention is not intended to be limited to the details shown. Rather various modifications may be made in the details within the scope and range of the equivalence of the claims and without departing from the invention.

What is claimed:

1. An image processor for setting a clip point at an intensity level below which pixel values from an image are suppressed, the image processor comprising
a raw histogram module for computing a raw histogram of pixels in the image;
a clip point positioning module for positioning a clip point at a pixel intensity level within the raw histogram; and
a suppression module for reducing the intensity levels of the pixel values in the image that are lower than the intensity level of the clip point.

2. The image processor of claim 1, wherein
the clip point positioning module positions the clip point at a low intensity level within the raw histogram.

3. The image processor of claim 1, wherein
the clip point positioning module positions the clip point at an intensity level within the raw histogram corresponding to a bin having the greatest number of pixels per bin.

4. The image processor of claim 1, including
a contrast stretch module which stretches the raw histogram of the image; and
a display space mapping module which maps the stretched histogram and the clip point to a reduced bit level display histogram,
wherein a positional relationship between the raw histogram and clip point is similarly maintained between the display histogram and mapped clip point.

5. The image processor of claim 4, wherein
the suppression module produces a clipped image by reducing the intensity level of the pixels in the display histogram that have an intensity level lower than the intensity level of the clip point.

6. The image processor of claim 5, including
a display for displaying the illuminated pixels remaining in the clipped image.

7. The image processor of claim 1, including
a micro-bolometer sensor for generating the image being processed by the image processor,
wherein the raw histogram is computed from the image produced by the micro-bolometer sensor.

8. A thermal video camera system, including
a micro-bolometer sensor for producing a raw thermal image;
an image processor for processing the raw thermal image,
wherein the image processor includes:
a raw histogram module for computing a raw histogram of the raw thermal image pixel values,
a clip point positioning module for positioning a clip point at a pixel intensity level within the raw histogram, and
a suppression module for reducing the intensity levels of the pixel values in the thermal image that are lower than the intensity level of the clip point; and
a display device for displaying the processed thermal image.

9. The thermal video camera system of claim 8, wherein
the clip point positioning module positions the clip point at a high intensity level within the raw histogram.

10. The thermal video camera system of claim 8, wherein
the clip point positioning module positions the clip point at an intensity level within the raw histogram corresponding to a bin having the greatest number of pixels per bin.

11. The thermal video camera system of claim 8, including
a display space mapping module that maps the raw data histogram and clip point to a reduced bit level display space.

12. The thermal video camera system of claim 11, wherein
the suppression module produces a clipped image by blacking-out the pixels in the display space that have an intensity level lower than the intensity level of the clip point.

13. The thermal video camera system of claim 12, wherein
the display displays the illuminated pixels remaining in the clipped image.

14. The thermal video camera system of claim 13, including
a manual control module allowing a viewer to manually adjust the clip point position set by the clip point positioning module for changing the number of illuminated pixels being displayed,
wherein the clip point is manually adjusted by the viewer after the clip point positioning module initially positions the clip point in the raw histogram.

15. The thermal video camera system of claim 14, including
an automatic temperature compensation module which controls the clip point positioning module to adjust the clip point based on a focal plane temperature or an enclosure temperature.

16. A method for setting a clip point below which low intensity pixel values from an image are suppressed, the method comprising the steps of:
computing the raw histogram of the image;
positioning a clip point at an intensity level within the raw histogram;
contrast stretching and mapping the raw histogram to a reduced bit level display histogram; and
blacking-out the pixels having intensity lower than the intensity level of the clip point.

17. The method of claim 16, wherein
the clip point is positioned at a low intensity level within the raw histogram.

18. The method of claim 16, wherein
the clip point is positioned at an intensity level within the raw histogram corresponding to a bin having the greatest number of pixels per bin.

19. The method of claim 16, wherein
the illuminated pixels remaining in the clipped image are displayed.

20. The method of claim 19, wherein
the number of illuminated pixels in the displayed image are changed by manually adjusting the position of the clip point.

21. The method of claim 16, wherein
the clip point is repositioned as the raw histogram changes with changes in scene conditions and operating environments, to continuously maintain a position within the he raw histogram.
